(19) United States
(12) Patent Application Publication
(10) Pub. No.: US 2006/0200370 A1
(43) Pub. Date: Sep. 7, 2006

(54) Availability-based pricing for multi-channel distribution

(75) Inventors: Richard M. Ratliff, Flower Mound, TX (US); Dirk Guenther, Roanoke, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SABRE, INC.

(21) Appl. No.: 11/072,059

(22) Filed: Mar. 4, 2005

(51) Int. Cl. G06Q 10/00

(52) U.S. Cl. 705/5; 705/400

(57) ABSTRACT

A method, system, and computer readable medium for adjusting prices is provided and includes receiving at least one itinerary having an associated price, and modifying the availability of at least one component of the itinerary across a plurality of distribution channels. The method, system, and computer readable medium may also include modifying the availability to generate a more competitive or profitable price for the itinerary and outputting the competitive price and the itinerary. In addition, the method, system, and computer readable medium may include determining the availability of a roundtrip itinerary in a single transaction with a computerized reservation system and modifying the availability of the roundtrip itinerary.

### BACKGROUND OF THE INVENTION

1) Field of the Invention

The present invention relates to availability-based pricing and, more particularly, to a system and method for availability-based pricing of fares through multiple distribution channels to generate increased revenues.

2) Description of Related Art

Reservation systems and Internet fare search engines use specialized techniques to review fare offerings, both published and unpublished (i.e., specially offered fares not normally available), across a number of different vendors (e.g., airlines, car rental companies, hotels, and the like) and return these results to the buyer in some ranked ordering based on the attributes the customer has requested, such as by price. Each travel vendor's system allows the fare search engines to determine which of their fares are available for the dates and itinerary being considered, and the fare search engines sort and select the best alternatives. The objective of traditional fare search processing is to find the best fare offers available in the marketplace.

In the context of the airline industry, current airfare, which is returned to the fare search engine for a given market pair (e.g., Washington to London), may be either overpriced and/or unavailable. Thus, the fare is determined to be uncompetitive with other airlines for the same market pair. When a consumer seeks to book an itinerary for this market pair, conventional systems respond with information on all airlines with available seats on aircraft serving the market pair, including both the competitive and uncompetitive prices. The airline having a current published fare (or a special offering not normally available from the airline (an unpublished fare)) that is uncompetitive is, therefore, likely not to be chosen by a buyer. While an uncompetitive supplier may have the inventory to fulfill a request, the uncompetitive supplier may have too high a price to compete effectively. Conversely, a supplier's fares may be much lower priced than any of its competitors for the same request, which creates an opportunity for an on-line fare increase while still being competitive (i.e., upsell or sellup).

Fares are dependent upon a number of factors, including availability and published fares. Real-time Direct Connect Availability (“DCA”) processing is one method for obtaining availability information. In DCA processing, the airline computerized reservation system (“CRS”) itself serves as the master copy of current availability status, and distribution partners (either global distribution systems or travel websites) use real-time linkages to check the airline CRS for the exact availability status at that specific instant in time. Because of these explicit real-time checks, DCA provides very high assurance that the consumer can actually purchase a seat(s).

Note that an airline CRS may elect not to use DCA processing for obtaining availability status (due to extra costs of connectivity and upkeep). In such situations, an alternative asynchronous update mechanism is commonly used in the airline industry and is known as AVS (“availability status”). AVS updates are open/close messages that are distributed by airlines to all distribution channels (both DCA-connected and those that are not). Because their level of control is not very detailed and due to delays in processing and transmission, AVS updates are regarded as inferior to DCA.

The traditional “static” fare filing process is exemplified by one of the major airline fare update vendors. Most airlines worldwide subscribe to services provided by the Airline Tariff Publishing Company (ATPCO). Note that a similar process is utilized by another leading vendor (Societe Internationale de Telecommunications Aeronautiques, “SITA”). ATPCO provides electronic tape records (and file transfers) that contain both published (i.e., available to any travel agent) and private (i.e., special, negotiated) fares. The records are updated several times per day according to a specific schedule. Airlines send (also known as file) new fares or changes to existing fare amounts according to these ATPCO publication schedules. ATPCO compiles all the new and changed fare records received from the respective airlines into a master database, and this updated information is subsequently distributed to all the subscribing airlines and global distribution systems (“GDS's”) worldwide. The GDS's are the systems used by travel agencies to check flights, fares, availability and to make travel bookings. The GDS's upload these fare revisions into their respective fare databases. Once the GDS uploads are completed and applied (typically this processing takes an hour), travel agents are able to view the new fare levels for any of the subscribing airlines. The end-to-end fare filing process is illustrated in FIG. 1, where the process typically takes 2-12 hours to complete. The process generally includes airlines making fare changes and sending these changes to ATPCO (block 10), and ATPCO stores the changes in the master database and sends the changes to airlines and GDS's (block 12). Once the GDS's receive the modified fares, the GDS's update their pricing databases such that the results are available to travel agencies and websites (block 14).

FIG. 10 illustrates examples of the type of information provided on published fares offered by one commercial airline. The specific fare used in this example is the VE14NS fare (for the O&D roundtrip from Charlotte, N.C. to Kansas City, Mo.). The fare is booked in “V” class and is subject to “V” class availability. The fare is non-refundable and must be purchased 14 days before departure. The “eff/exp” restrictions relate to the effective date range (from the July filing date through November 19) for which the fare is valid and that there is no current expiration date on this fare. Also, there are no listed restrictions on the day of the week or time of day for travel, and there are also no restrictions on “fit appl” (i.e., it is applicable for any flight). This type of fare is very typical in that: 1) it is valid across a wide range of travel dates and flights, but 2) is subject to availability of its associated fare class.

The fare publication services provided by both ATPCO and SITA are the primary mechanism used by the airlines to assess their relative competitiveness in the travel marketplace. The information provides the ability for airlines to review the published fare levels for each separate origin-destination (O&D) market, the date ranges for which those fares apply, and the unique restrictions associated with each fare type (e.g., 14 day advance purchase). Airline decision support tools are utilized to perform automated checks of fare and rule differences between the latest and the previous ATPCO fare loads. These checks can highlight the specific markets and dates that require the most urgent attention by the airline pricing analyst. This fare review process, along with associated corrective actions on the part of the pricing analyst, has worked well for over two decades. However, there are limitations to this approach.

Two important factors that are not considered in the ATPCO or SITA information (by itself) include availability and recent advances in more powerful low-fare search engine technology. With the possible exception of unrestricted “full” fares, published fares don't provide a true indication of an air carrier's actual marketplace competitiveness. That's because the majority of fares actually purchased by travelers are subject to availability. Even if an airline has filed fares that exactly match a competitor's amounts and restrictions, the airline isn't actually competitive (on specific flights and dates) unless the fare classes associated with those fares are available. The converse is true also. A particular airline may lower its fare amounts in order to match a competitor's filed fares, while in practice that competitor has very limited availability (e.g., only a few seats on off-peak flights). The net result is that the particular airline is generally lower in the marketplace than its competitor. Further obfuscation derives from modern low-fare search technology which can identify (unintended) combinations of separate “local” fares that may be less expensive than the fares filed in a specific O&D. For example, suppose the LE14NR fare from Miami-Pittsburgh is $298. If the TEX95NR fare from Miami-Raleigh/Durham is $139, and the NEX96N fare from Raleigh/Durham-Pittsburgh is $129, then advanced low fare search engines can readily determine that a customer can save money by purchasing two local fares ($139+$129=$268) instead of the published fare for the Miami-Pittsburgh O&D. These types of sales are termed “sum-of-locals.” Such situations are obviously dependent on the availability circumstances associated with the specific flights and dates involved, and such circumstances can change rapidly as new sales and cancellations occur on the flights. Thus, changes to published fares, “sum-of-locals” possibilities, and the availability status of the particular flights and dates considered all result in large variations in the effective fare levels in the marketplace.

The problem is further compounded by differences in content and availability by distribution channel (also known as point-of-sale or POS). Access to private, special fares and availability that are unique to a given travel agency are another source of competitive differentiation. In an attempt to better manage the effective marketplace fare across various distribution channels, airlines with advanced inventory management systems employ POS availability controls. These POS controls are used to adjust availability across a particular distribution channel (or for a specific travel agency).

The economic dynamics of competing distribution channels may create circumstances in which the carrier's objectives and those of its distribution partners may diverge. A common example where multi-channel management of dynamic pricing becomes important is in fare upsell situations. If a carrier is “overcompetitive” (i.e., effective fare levels are too low) on a given market and date, it will determine that the expected value of sales in that market and date would be maximized by raising the effective fare level. One approach to fare upsell is to dynamically apply an increase to the fare amount on the flight(s) involved on that market and date. However, if this dynamic pricing technology were limited to a single distribution channel (e.g., travel agents using the Sabre GDS), then the agents using that channel would be at a competitive disadvantage compared to travel agents using other GDS's (because the “corrected” fare in Sabre would be higher than anywhere else).

Furthermore, because of inherent limitations in current availability processing control technology, it is not possible to achieve fully independent fare availability control for each separate market, itinerary, departure and return date combination. As such, changing availability controls to correct for a known problem on a specific market and date will generate unintended, second-order changes on other (different) market and dates. These inadvertent effects arising from a specific change are conceptually similar to “externalities” in economics, a concept well known to those skilled in the art. There are three commonly used types of inventory control processing in the airline industry, which generally result in unintended 2^{nd} order effects. The three common types of inventory control framework are (in increasing order of effectiveness): 1) leg-based controls, 2) O&D controls, and 3) O&D with time-of-day override controls.

Leg-based controls treat each flight leg as an independent entity. Hence, by closing V-class on a particular market, any V-class fares in other markets that utilize the same flight legs will also be made unavailable. This is an example of an unintended 2^{nd} order impact arising from forcing upsell in a particular market. In addition to affecting fare availability in local and other connecting markets by closing V-class on a specific date for flight departures, other departure/return date combinations are impacted. If a competitor had a lower fare available for passengers departing on an alternate roundtrip date, then the revenue gained from the original upsell action could be offset by revenue losses arising from making the competitor more competitive to customers on the alternate roundtrip date.

O&D controls are also used for inventory control. For multi-channel availability based pricing, V-class would ideally be closed for the original itinerary while still allowing V-class to be available to local (or other connecting market) passengers. Airlines that use O&D controls can differentiate between various passenger types based on the revenue value of the various O&D's and fare classes flowing over a particular flight leg. As such, if V-class for the original itinerary were closed, any other lower-valued O&D-fare class sales would also be made unavailable. However, any higher-valued O&D fare class sales would remain open (including V class in some long-haul markets). Thus, the 2^{nd} order effects of dynamic availability modifications are lessened compared to leg-based controls, but there are still some unintended impacts. Also, the problems cited previously regarding the alternate roundtrip dates still remain as a problem.

Although the O&D control difficulties described above still remain problematic, airlines that utilize market/date/time-of day overrides have an improved ability to perform multi-channel availability-based pricing. These override controls allow independent adjustment of the revenue value by O&D market/date/time-of day. In practice, a market for a particular fare class and date can be devalued such that it becomes unavailable, without impacting the availability of any other O&D-classes. Furthermore, time-of-day controls (usually limited to morning or evening flights considered as a group) are helpful in situations where there are multiple flights per day servicing a particular market. However, the problems cited previously regarding the alternate roundtrip dates still remain as a problem.

It would therefore be advantageous to provide a system that is capable of determining and implementing price adjustments across multiple distribution channels simultaneously. It would further be advantageous to provide for a system that is capable of performing availability-based pricing across multiple distribution channels that minimizes unintended second order effects. It would also be advantageous to provide a system that is capable of calculating the revenue associated with the effects of performing availability-based pricing across multiple distribution channels. Finally, it would be advantageous to provide a system that is capable of updating yield management systems by taking into account availability-based pricing across multiple distribution channels and the effects thereof.

### BRIEF SUMMARY OF THE INVENTION

The invention addresses the above needs and achieves other advantages by providing a system and method for availability-based pricing through multiple distribution channels to generate more competitive or profitable prices. The present invention utilizes fully independent roundtrip itinerary controls to minimize secondary effects associated with modifying the availability, as well as to estimate the overall revenue impact of a price availability change. Moreover, the present invention is capable of refining one or more options to determine the best decision for modifying the availability and to estimate the impact on an airline's revenue.

In one embodiment of the present invention, a method for adjusting prices is provided and includes receiving at least one itinerary having an associated price, modifying the availability of at least one component of each itinerary across a plurality of distribution channels to generate a more competitive price for the itinerary, and outputting the competitive price and the itinerary.

In various aspects of the method, the method includes modifying the availability of a class, such as closing a lower priced class, to generate the more competitive price, resulting in increased revenues. The method could include modifying the availability of the at least one component of the itinerary based on an expected revenue for each of a plurality of differently priced itineraries and/or prices for each of a plurality of competitor's itineraries. Modifying may occur in real-time and simultaneously across the plurality of distribution channels. In addition, the plurality of distribution channels may include a plurality of global distribution systems.

In additional aspects, the method includes determining a probability of selecting the itinerary and calculating an expected revenue for the itinerary. The availability of the at least component of the itinerary may be modified across a plurality of distribution channels based on the probability and expected revenue, wherein the availability of the itinerary is modified to increase the expected revenue. The probability may be determined using a customer choice model, such as a multinomial logit choice model. The customer choice model could be calibrated using a conditional logit regression model.

Further aspects of the present invention include identifying an opportunity to modify the availability of the at least one component of the itinerary. The method may also include determining a plurality of options to generate a more competitive price for the itinerary, and refining at least one of the options. Identifying an opportunity may include identifying a probability of selecting a respective itinerary using a customer choice model. The determining step may include determining a set of more competitive prices and a set of respective itineraries, where the set of respective itineraries is dependent on leg based, origin and destination based, and/or origin and destination with time of day based itinerary controls. The determining step could also include computing a demand for purchasing the plurality of options, which typically includes computing a probability of purchasing the plurality of options.

The step of refining could include computing revenue resulting from modifying the availability of at least one of the plurality of options, which generally includes computing the revenue with a bid price model and a modified bid price model. In one embodiment, refining includes determining the difference between the revenue computed by the bid price model and the modified bid price model. Computing the revenue with the modified bid price model could include adjusting demand for one of the plurality of options to reflect the effect of modifying the availability, as well as adding a constraint in dual space to require modifying the availability. The method could include terminating the refining step when a more competitive option is determined, or each of the plurality of options could be refined. In addition, at least one previously refined option could be refined such that the option is re-validated. In addition, the method may include updating an airline yield management system to account for modifying the availability.

In methods discussed above, a computer-readable medium containing instructions may be constructed for causing a computer to perform the method. Moreover, the method may also be embodied in a system for adjusting prices that includes at least one processing element for receiving at least one itinerary having an associated price, modifying the availability of at least one component of the itinerary across a plurality of distribution channels to generate a more competitive price for the itinerary, and outputting the competitive price and the itinerary. The system could also include a client device for inputting a request for travel.

Various aspects of the system include a processing element that determines a probability of selecting the itinerary and calculates expected revenue for the itinerary. The processing element could then modify the availability of the itinerary across a plurality of distribution channels based on the probability and expected revenue. In one embodiment of the present invention, the processing element determines the availability of a complete roundtrip itinerary in a single transaction with a computerized reservation system. In an additional embodiment, the processing element identifies an opportunity to modify the availability of the itinerary across a plurality of distribution channels to generate a more competitive price for the itinerary. The processing element could determine a plurality of options to generate a more competitive price for the itinerary, and then refine at least one of the plurality of options. In yet another embodiment, the processing element may update an airline yield management system to account for modifying the availability.

In another embodiment of the present invention, a method for adjusting prices includes receiving at least one roundtrip itinerary, determining the availability of the roundtrip itinerary in a single transaction with a computerized reservation system, and modifying the availability of at least one component of the roundtrip itinerary across a plurality of distribution channels. An option of the method includes determining whether a carrier includes an inventory control for the at least one roundtrip itinerary. The method could also be embodied in a computer-readable medium containing instructions that may be constructed to cause a computer to perform the method. Moreover, the method may also be embodied in a system for adjusting airline fares that includes at least one processing element for performing the method.

This proposed real-time process is an improvement over traditional, manual approaches involving large-scale, batch updates of many airfares every few hours, and availability-based pricing provides a more practical means of achieving detailed airfare control for specific markets and dates. Such improvements directly translate to additional revenue for airlines utilizing this technology, as availability-based pricing reduces marketplace inefficiencies by allowing immediate correction of airfares based on the exact competitive situation at the instant of the transaction. These benefits are well known by those skilled in the art.

Moreover, the invention provides a highly effective means of precisely managing a carrier's fare competitiveness in a given market. In effect, it gives the carrier the opportunity to make a real-time price decision (for a specific customer request) after having fully considered the competitive landscape (at that particular moment in time). It provides a major revenue advantage for the carrier using the technology by increasing the expected value of the sale on each transaction. However, unless dynamic pricing technology is employed across all of a carrier's distribution channels, it can lead to significantly inconsistencies in the effective fare levels by channel.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is flowchart illustrating a process of publishing fares and updating the fares on global distribution systems, according to one conventional technique;

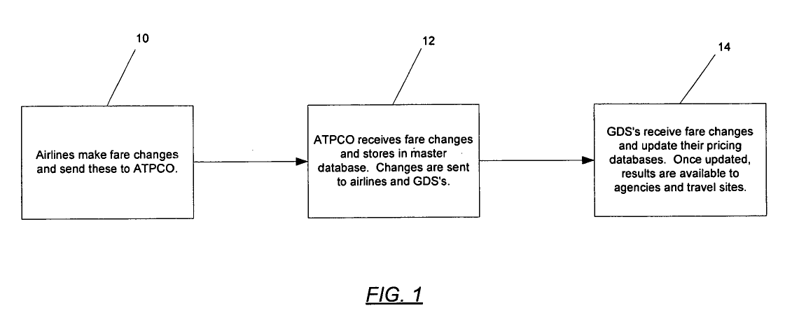

FIG. 2 is a pictorial diagram illustrating a client-server network, according to one embodiment of the present invention;

FIG. 3 is block diagram illustrating real-time direct connect availability processing, according to one embodiment of the present invention;

FIG. 4 is flowchart illustrating a method for modifying fares across a plurality of distribution channels, according to one embodiment of the present invention;

FIG. 5 is a graph illustrating the hierarchy of airline CRS availability processing controls, according to one embodiment of the present invention;

FIG. 6 is a flowchart illustrating a method for modifying the availability of an itinerary across a plurality of distribution channels, according to one embodiment of the present invention;

FIG. 7 is a flowchart illustrating a method for modifying the availability of an itinerary employing fully independent roundtrip itinerary controls, according to one embodiment of the present invention;

FIG. 8 is a flowchart illustrating a method for utilizing an opportunity calculator, according to one embodiment of the present invention;

FIG. 9 is a flowchart illustrating a method for updating an airline yield management system, according to one embodiment of the present invention;

FIG. 10 is a table showing information relating to published fares, according to one conventional technique; and

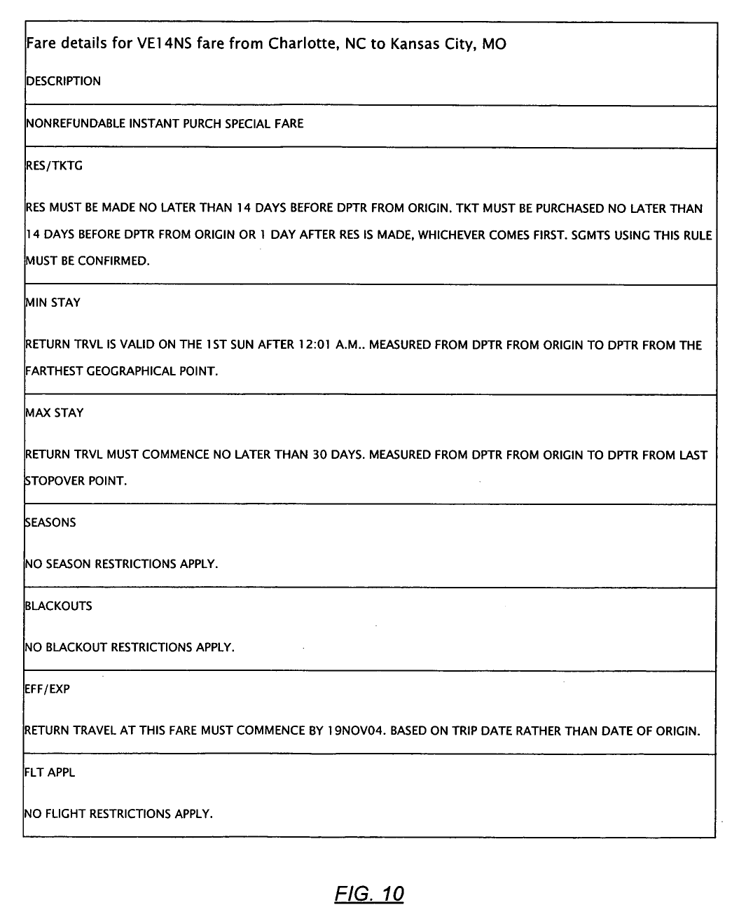

FIG. 11A-B are tables depicting examples of information used in determining fully independent roundtrip itinerary controls, according to one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

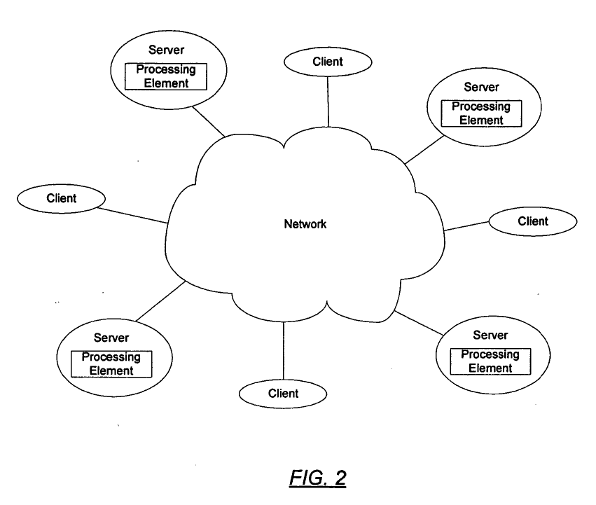

Referring now to the drawings and, in particular to FIG. 2 there is shown a network, wherein a plurality of servers and clients communicate through a network. For instance, clients may communicate with servers to obtain fare and availability information for a requested itinerary. The present invention is applicable to travel industries such as aircraft, automobile rental, rail, hotel, and the like that employ distribution channels to manage availability, but is not limited thereto. Thus, although reference is made herein to the airline industry, such reference is exemplary only, as the invention is applicable to various travel-related industries.

As referred to herein, the terms “client” and “server” are generally used to refer to a computer's role as a requester of data (i.e., the client) and a provider of data (i.e., the server). The client and server may communicate via a communication network, such as the Internet, an intranet, an extranet, or any other suitable network. As also used herein, the term “client” corresponds to any suitable computing device, typically a computer, a personal data assistant, mobile phone, or the like, capable of communicating with a server. Likewise, the server is generally comprised of a processing element such as a computing device having at least one or more processors and associated memory device(s) as known to those skilled in the art. The client and server may comprise any number of conventional components but typically include a bus, central processing unit (CPU), read-only memory (ROM), random access memory (RAM), storage device, input/output controller, and network interface, and may operate at least partially under the control of one or more software programs or other applications, as all known to those skilled in the art. Any number of clients and servers may be included in the system and in communication with one another.

Availability Changes Across Multiple Distribution Channels

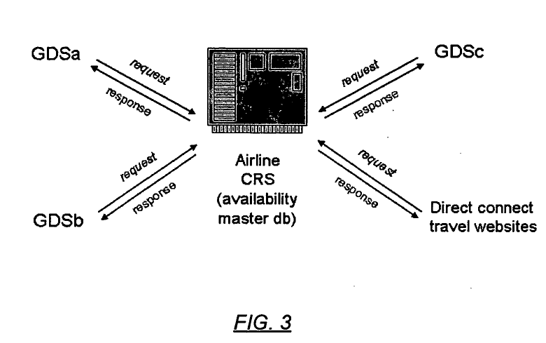

Referring now to the drawings and, in particular to FIG. 3 there is shown a plurality of distribution channels that may obtain availability information for itineraries from an airline CRS. Thus, DCA processing could be employed, where the airline CRS serves as the master database and distribution partners use real-time linkages to check the airline CRS for the exact availability status at that specific instant in time. As described below, the availability information may be used in accordance with embodiments of the present invention to determine whether a more competitive fare may be realized by modifying the availability.

As used herein, the term “distribution channel” is not mean to be limiting and could be any travel distribution channel such as those provided by the internet, suppliers, GDS's, and travel agents. The internet provides distribution channels through online travel agents (e.g., Travelocity), supplier websites, and auction and reverse auction outlets acting as mediators between suppliers and consumers. Typical GDS's include Sabre Travel Network, Galileo International, Amadeus, and World Span. For the purposes of this description, a supplier may be any product or service provider comprising an airline, an intermediary entity that resells product or services, or any travel fulfillment entity.

In addition, fares are provided for an associated itinerary, where the itinerary corresponds to a proposed route of travel. As such, the term “itinerary” is also not meant to be limiting and is applicable to any number of travel industries, such as those discussed above, and would include various travel plans for a specified route. In addition, each itinerary has one or more components associated therewith. For instance, the components could be O&D, dates, and fare classes for an airline flight, as well as check-in and check-out dates for hotel accommodations, or requested days for car rentals. Moreover, although reference is made to modifying the availability of the itinerary to generate a more “competitive fare,” the term competitive fare is not meant to be limiting. In particular, it is understood that the competitive fare could also, or alternatively, be more profitable by modifying the availability of the itinerary.

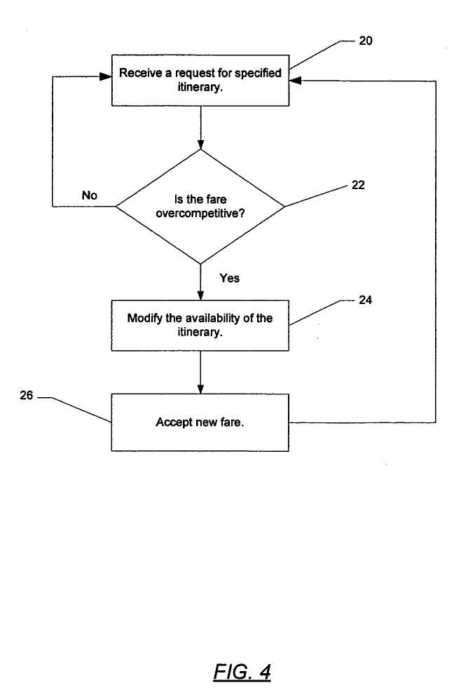

As addressed below, embodiments of the present invention at least partially remedy situations in which a supplier (or retailer) is incorrectly priced by selectively changing availability. One common situation addressed by embodiments of the present invention involves enforcing upsell to a higher fare type. Stating it another way, the availability of the lower fare can be closed (i.e., made unavailable) thus raising the effective price (for the specific itinerary involved) to a different fare filed in the next higher class. Another common situation involves reducing the effective fare amount by opening up a previously closed class. Therefore, the embodiments of the present invention use availability as a mechanism for changing the effective fare, rather than modifying the current fare level itself. For example, FIG. 4 illustrates a method for modifying the availability of the fare when the fare is overcompetitive. A user typically requests an itinerary that is associated with a fare (block 20). If the fare is overcompetitive (block 22), the availability of the itinerary may be modified (block 24) to generate a more profitable fare. When the fare is accepted (block 26), the fare is provided with the itinerary to the user.

Since DCA involves real-time availability checks by major distribution partners, it provides a basis for changing effective fare levels across any distribution channel utilizing DCA (or variations of DCA) processing. By opening (or closing) a fare class on a particular flight and date, the effective fare level for that flight and date will be lowered (or increased) because fares associated with that class will also be opened (or closed). Any subsequent fare search transactions occurring in a DCA-connected distribution channel will be provided real-time information on the specific fare classes that are available for that flight and date, so airline CRS availability changes provide an immediate mechanism for controlling the effective fare across multiple distribution channels. Typically, DCA may obtain availability updates in 1 to 4 seconds, and the airline CRS may be updated simultaneously. As noted above, AVS may also be used to obtain availability updates. Thus, in the context of multi-channel dynamic pricing, AVS updates are another mechanism that can be employed to change the effective fare levels through availability.

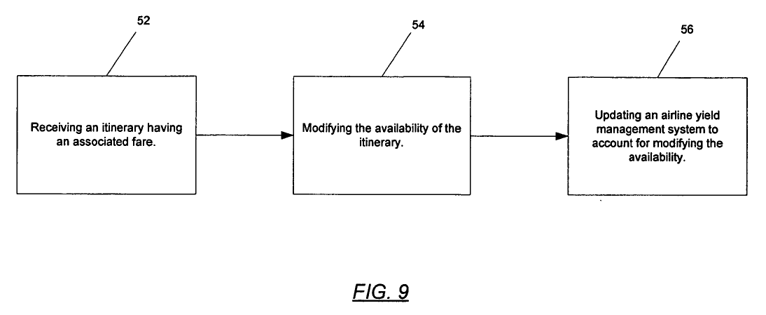

Airline yield management systems are also advantageously updated to reflect the availability changes. FIG. 9 demonstrates that after receiving a fare (block 52) and modifying the availability of the associated itinerary (block 54), the airline yield management system may be updated to reflect the changes made by modifying the availability (block 56). Thus, the updates to the airline yield management system would take into account any availability overrides and/or dynamically repriced airfares. Airline yield management systems, as known to those skilled in the art, utilize historical data and future projections based on trends, bookings, and other information that may affect the marketability of fare classes. Airlines use forecasting models to predict future demand and cancellations to make decisions regarding flight overbooking, discount-fare management, and itinerary control. In this regard, availability updates could be provided to the airline yield management system periodically (e.g., one or more times a day) so that airlines may make more accurate forecasts.

There are several practical advantages of an availability-based approach in lieu of a dynamic re-pricing of the fare itself. Availability changes are relatively easy to make from a data processing viewpoint, and since most modern airlines have direct-connect availability linkages in place with their distribution partners as exemplified by FIG. 3, effective fare changes made via availability can be implemented across multiple channels instantaneously. In addition, availability changes can be executed very rapidly (in real-time if needed), and can avoid the effort and time lag associated with filing a fare change (with the re-priced amount). In addition, availability usually allows more finely tuned control changes than can be achieved by changing fare amounts.

Fully Independent Roundtrip Itinerary Controls

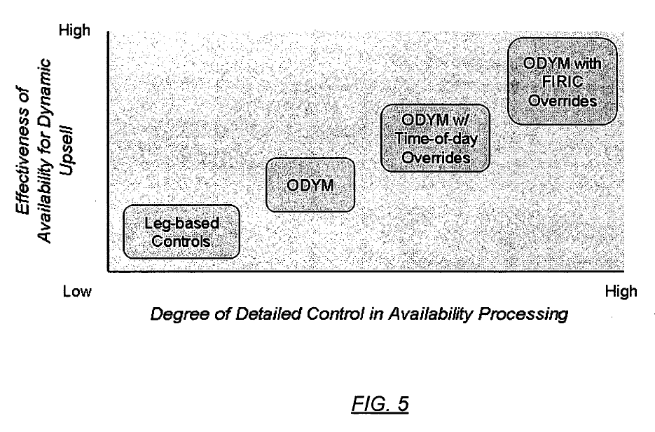

The control capability for use in multi-channel availability-based pricing advantageously involves independent overrides at the round-trip/itinerary/departure date/return date/fare class (or fare basis code)/POS level of detail. Such precision (hereafter referred to as “fully independent round-trip itinerary controls” or FIRIC) provides the maximum freedom for a carrier to maximize or otherwise increase its expected revenue based on its own and competitive product offerings at any particular point in time. In addition, FIRIC eliminates the secondary effects described above and as shown in FIG. 5, FIRIC provides greater effectiveness than other types of inventory control processing as the degree of detailed control increases.

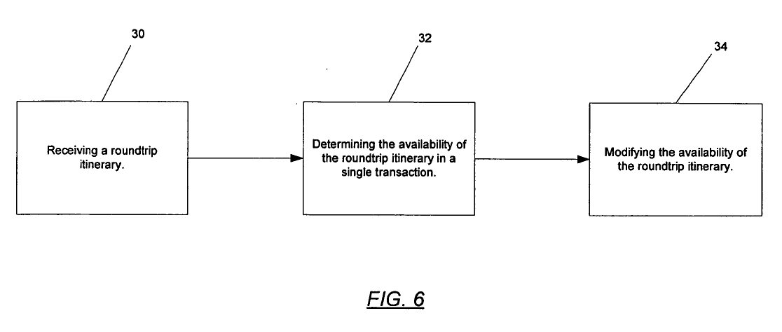

In practice, this FIRIC capability could be incorporated into a carrier's existing inventory control processes. The chief implementation obstacle involves the functions that invoke and utilize availability sub-processes, as none of these functions currently make use of round-trip availability. Instead, current airline inventory processes are based only on a single date and, thus, do not take into account the practice of separate availability control for various combinations of round-trip dates (i.e., both the departure and return date). However, there are two commonly used airline sales functions that do utilize round-trip concepts, which are airline pricing and journey controls. For these two functions to utilize round-trip controls, they would need to be modified to make a single call to check O&D/itinerary/date availability at the round-trip level (rather than two separate calls, one for the departure and another for the return). Thus, as shown in FIG. 6, after receiving a roundtrip itinerary (block 30), the roundtrip availability may be determined in a singe transaction (block 32) prior to modifying the availability of the itinerary (block 34).

To enable fully independent round-trip itinerary controls, an airline's current CRS availability processing could be modified to include an additional control step. This additional processing step would involve a separate, override exception table lookup to see if there are any items that involve the specific round-trip itinerary being considered. This override table lookup processing could potentially be performed either: 1) in parallel to existing inventory processes, 2) prior to performing the existing inventory control processing, or 3) following completion of the existing inventory control processing. The selection of the appropriate order of processing would be dependent upon the specific implementation by the airline CRS, but any of the three approaches would suffice for multi-channel dynamic pricing.

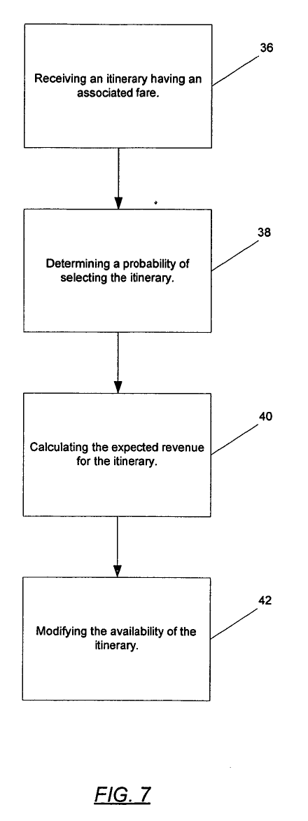

FIRIC is generally depicted in FIG. 7 and could be performed by, for example, a processing element or server. FIRIC includes receiving a fare for an associate itinerary (block 36) and determining a probability that the itinerary will be selected (block 38). The expected revenue is calculated for the itinerary (block 40), and the availability of the itinerary is modified based on the probability and expected revenue (block 42).

The probability of selection of an itinerary is calculated with customer choice models (CCM) such as, for example, multinomial logit choice models. Multinomial logit choice models are used to estimate the probability of selecting specific itinerary and fare alternatives returned from the fare search results. The models may be carried out, for example, by a processing element or server. Assuming that an itinerary is actually booked by the customer, these models are used to compute the probability of each particular option being selected. Note that this approach is equivalent to estimating the market share of each option (for this booker). To calibrate these models, conditional logit regression models use historical shopping sessions involving actual travel purchases. Utility points are assigned to each different characteristic (denoted as “j”) of the flights and fares considered. These characteristics may include, for example, time-of-day, non-stop or multi-stop, and percentage difference versus lowest fare returned. Various other factors that differentiate the quality of service can be considered using this approach. As is well known to those skilled in the art, the utility and estimated share (for option “i”) are derived using the following equations:
Utility for optionᵢ=Uᵢ=Σⱼ (points by factorᵢⱼ)
Estimated share for optionᵢ=(e^{Ui})/(Σⱼe^{Ui})

In practice, current airline CRS's would need to redevelop their inventory management systems (both the offline yield management decision support tools as well as real-time inventory processing systems) to include a FIRIC override capability. An existing capability that is related to (but distinct from) FIRIC is known as “journey control” or “married segment control.” Journey controls are used to enforce O&D inventory processing logic at the itinerary level during the passenger booking process to prevent independent booking of flight legs in an attempt to circumvent O&D availability restrictions. However, journey controls do not provide an ability to independently manage availability in the manner achieved by FIRIC.

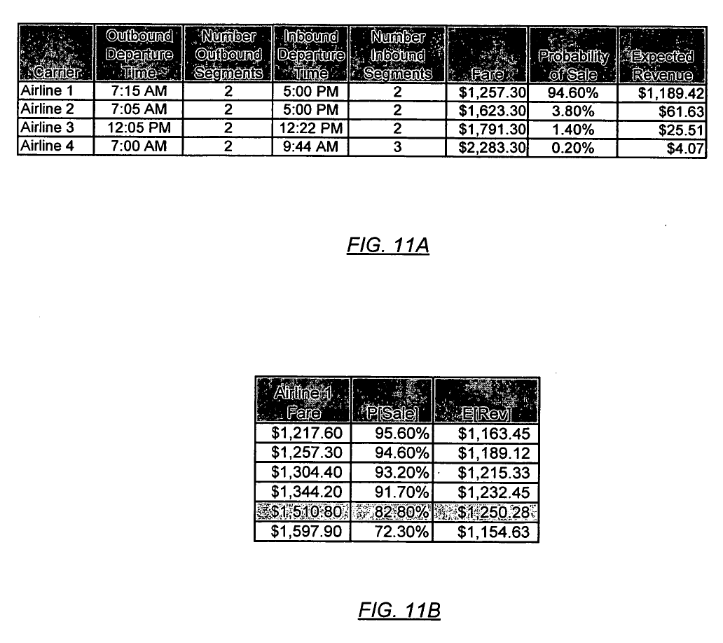

An example of how multi-channel availability-based pricing would work in the ideal inventory control framework (e.g., O&D inventory controls with FIRIC overrides) is illustrated in FIG. 11A-B, where the fare, probability of selection, and expected revenue were determined for each Airline. Note that the Airline 1 option is a 1-stop service with a connecting flight in Pittsburgh (e.g., SAN-PIT connecting to PIT-CUN), and the specific travel dates considered were departure on April 1 and return on April 7. At $1,257, the Airline 1 “VXNR” (subject to V-class availability) airfare is significantly lower than the competitor offerings in the SAN-CUN market, and the next best offering (Airline 2) is priced at $1,623. Using CCM's to estimate the probability of selection P[Sale] for each competitive itinerary, the expected revenue E[Rev] for each carrier can be calculated (See FIG. 11A). In this example, various fares of Airline 1 for different classes, but for the same O/D and departure and return dates were assessed to determine their expected revenue in this competitive scenario. FIG. 11B illustrates that as the fare increases, the P[Sale] decreases, and although the E[Rev] increases with the fare, the E[Rev] reaches a point where it will begin to decrease following a maximum expected revenue. The maximum E[Rev] of $1250 was achieved with the $1,510 fare (See FIG. 11B). Airline 1 can therefore increase its expected revenue in this session by about $60 [$1250.28-1189.42] if it closed availability to any inventory below the $1,510 fare level (which is the HWR fare, subject to H-class availability).

In the SAN-CUN example, use of FIRIC capabilities would ensure there are no 2^{nd} order effects and allow the full benefit of modifying availability to be realized. FIRIC in conjunction with multi-channel availability-based pricing allows maximum expected revenue on each fare shopping transaction (with minimal 2^{nd} order effects). For the SAN-CUN example, FIRIC availability would allow the $60 expected revenue increase to be achieved without untoward effects on other markets and date.

Opportunity Calculator

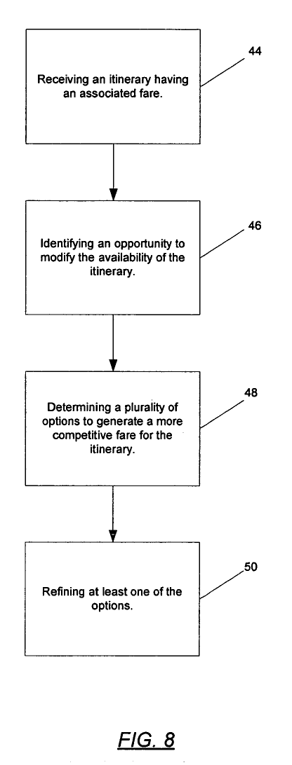

As mentioned above, the benefit of acting on an upsell opportunity is either magnified or reduced by 2^{nd} order effects, i.e., price changes on other itineraries that result from the upsell. The magnitude of 2^{nd} order effects depends on the type of inventory control used, such as leg-based controls, O&D controls, and O&D with time-of-day override controls. Thus, although the FIRIC may be used to minimize 2^{nd} order effects, FIRIC does not provide a technique for quantifying or otherwise taking into account 2^{nd} order effects when determining expected revenue. Thus, the FIRIC is a control mechanism, while the opportunity calculator is used to determine what availability controls to apply. As such, the opportunity calculator is used to determine the optimal upsell decision and to estimate the resulting net impact on the airline's revenue. FIG. 8 illustrates a method for optimizing or otherwise refining the upsell opportunity, where a fare associated with an itinerary is received (block 44) and an opportunity to modify the availability of the itinerary is identified (block 46). A plurality of options to generate a more competitive fare for the itinerary are determined (block 48) and at least one of the options is refined (block 50). In this regard, the opportunity calculator performs four basic steps:

1) Identify upsell opportunity.

2) Determine set of upsell options.

3) Refine and implement best upsell option.

4) Re-Validate upsell action.

In step 1) a CCM, typically carried out with a processing element or server, is used to determine the airline's expected revenue for different fare levels. Given a set of itineraries, the CCM determines for each itinerary the probability P[sale] that the customer will pick this itinerary. An upsell opportunity exists if there exists an upsell fare fₒₚₜ⁺ for the entire itinerary such that:
P[sale|f](f-π)<P[sale|fₒₚₜ⁻](fₒₚₜ⁺−π),
where f is the fare currently offered and π is the itinerary's opportunity cost. The opportunity cost is defined as the expected revenue of selling the itinerary in a later sales session, and is typically an output of the yield management system.

After identifying an upsell opportunity, a set of upsell options may be determined, which includes identifying the itinerary segment sᵢ best suited for upsell (Step 2), and where “i” designates each itinerary. For each segment, we consider the set Fᵢ⁺ of upsell fares and the set Iᵢ of itineraries that are effected by an upsell on sᵢ. The set Fᵢ⁺ is determined by comparing current available fares and modifying the availability of the itineraries. The set Iᵢ depends on the level of inventory controls:
Leg based: All itineraries flowing over sᵢ (independent of origin, destination and travel dates) are included in Iᵢ.

O&D based: All itineraries that serve the same O&D as the O&D in question and independent of travel dates and time of day are considered in Iᵢ.
O&D with Time of Day: All itineraries that serve the same O&D (independent of travel dates) are considered in Iᵢ.
   The impact on itineraries in Iᵢ is considered when computing the net revenue effect of an upsell on sᵢ. For each itinerary iₖ in Iᵢ, we compute the demand for the fare class associated with an upsell on sᵢ as:
   dᵢ₍ₖ₎(fₖ⁺)=dᵢ₍ₖ₎P[sale|fₖ⁺],
   where dᵢ₍ₖ₎ and fₖ⁺ are the total demand and the upsell fare for itinerary iₖ, respectively. Each carrier has a set of fare classes for each market, where the fare classes are arranged in a hierarchy. For example, let f₀ and fₙ be the lowest and highest fare classes, respectively. If a carrier closes fare class fᵢ, then fare classes fᵢ₊₁ receives (recaptures) some of the demand for fare class fᵢ. As a result, fᵢ₊₁ is labeled the fare class associated with an upsell from fare class fᵢ. The term P[sale|fₖ⁺] represents the purchase probability given fare fₖ⁺. As will be known to those skilled in the art, the purchase probabilities may be derived using shopping sessions relevant for iₖ. If no such sessions have been observed recently (within a user-defined time window) then such sessions are pro-actively generated using shopping robots.

The next step of the opportunity calculator is to refine and implement the best upsell option (Step 3). To do so, bid price models, carried out by a processing element or server, may be used to make an approximation of the upsell opportunity. The “bid price” is defined as the opportunity cost of having an unfilled seat at departure and is one form of availability control that airlines use to limit sales for lower-valued fare types. For example, airlines often stop selling discounted seats for a particular flight long before the flight is full. In essence the airline is predicting, based on available information (e.g., forecasts for this particular origin and destination (O&D), forecast variability, leg/cabin availability, etc.), that it will be able to sell the seat for later-booking, higher-valued travelers. Bid prices increase as higher valued demand increases, and these increases reflect the scarcity of the available resource (i.e., seats on the flight and date that everyone else is trying to book). The opportunity cost (bid price) of selling a seat at a discounted price is near zero only if demand is low and that seat would otherwise certainly be empty at departure. Given the impact on demand of itineraries in Iᵢ, a first approximation of the upsell opportunity on segment sᵢ can be computed as:

$$\begin{matrix}ΔProfit = d ( P [ sale \vert {f}_{i}^{+} ] ( {f}_{i}^{+} - π ) - P [ sale \vert f ] ( f - π ) ) + \\ {\sum }_{{i}_{k} ∈ {I}_{i}} {d}_{i ( k )} ( P [ sale \vert {f}_{k}^{+} ] ( {f}_{k}^{+} - {π}_{k} ) - P [ sale \vert {f}_{k} ] ( {f}_{k} - {π}_{k} ) )\end{matrix} ,$$

where
d: total demand for itinerary for which the upsell opportunity was identified (the “target itinerary”)
π: opportunity cost of target itinerary (i.e., leg bid prices)
πₖ: opportunity cost of itinerary iₖ
P└sale|f┘: probability of selling the target itinerary at its current fare
fᵢ⁺: probability of selling the target itinerary at its current fare

This heuristic ignores the effects that an upsell action on sᵢ has on opportunity costs for segments covered by an itinerary in Iᵢ. Consider, for example, an upsell on the SAN-PIT segment in the SAN-CUN example described above. All SAN-PIT round trip demands that use this SAN-PIT leg, such as SAN-PIT-DC-PIT-SAN, are affected by the upsell and some of them may be rejected because of the upsell. The airline is required to reduce its opportunity cost for the corresponding PIT-SAN legs to account for the reduced demand. These effects can be computed using modified versions of one of the traditional “bid price models” by:
Adjusting demand for the fare of the target itinerary and all itineraries in Iᵢ to reflect the effect of the upsell, and
Adding a constraint in the dual space to force the upsell:

$${\sum }_{l ∈ I} {π}_{l} > f ,$$
where I is the target itinerary and π₁ is the opportunity cost (dual) associated with leg l of the target itinerary.

The net benefit of the upsell on sᵢ is given by the difference in optimal primal objective function values of the modified bid price model and the original bid price model. The upsell is beneficial only if the optimal primal objective value of the modified model exceeds that of the original model. Note that the modified bid price model may choose to upsell on a segment other than sᵢ. To do so, the modified bid price model considers all of the carrier's itineraries for a particular O&D and departure and return dates. In this case the model underestimates the actual revenue benefit since re-capture effects on itineraries not in Iᵢ are ignored.

The evaluation process can be terminated as soon as an improving upsell is found. However, evaluating all upsell options may increase upsell benefits by identifying the upsell option that provides the greatest improvement. The modified bid price model may be too large to be solved within the given time limits. One can order all legs affected by the upsell in decreasing order of the expected impact on the upsell of the legs' opportunity cost. For each leg the change in revenue contribution for all itineraries in Iᵢ is computed as:

$$Δ Rev ( l ) = {\sum }_{k ∈ {I}_{i}} {f}_{k} ( l ) ( {d}_{i ( k )} ( {f}_{i}^{+} ) - {d}_{i ( k )} ( f ) ) ,$$

where fₖ(l) is the portion of the current fare for itinerary iₖ currently attributed to leg l. One can then choose either the top x legs from this order or all legs with ΔRe v(l)>T, where x and T are user-defined constants.

The opportunity calculator is used not only to identify and evaluate new upsell opportunities but also to periodically re-validate past upsell decisions (Step 4). Past upsell decisions are re-validated using the same models/approaches used to identify and evaluate new upsell opportunities. The frequency of re-validation depends on the markets in question. In particular, upsell decisions in frequently shopped markets are re-validated more often. One can use the number of shopping sessions (for a given market) since the last re-validation or an upsell decision as a trigger for re-validation. Re-validation is utilized to take into account fares, availability, and bid prices that change over time.

It is noted that although the above discussion and examples have been focused on increasing fares to increase expected revenue, it is understood that the fares may also be decreased to increase competitiveness and expected revenue. For instance, a fare that is overpriced may be reduced which may result in higher revenues when considering the increased competitiveness of the fare and the total sales that may result from decreasing the fare.

According to one aspect of the present invention, the system generally operates under control of a computer program product. The computer program product for performing the methods of embodiments of the present invention includes a computer-readable storage medium, such as the memory device associated with a processing element, and computer-readable program code portions, such as a series of computer instructions, embodied in the computer-readable storage medium. In this regard, FIGS. 4, 6-9 are control flow diagrams of methods and program products according to the invention. It will be understood that each block or step of the control flow diagrams, and combinations of blocks in the control flow diagrams, can be implemented by computer program instructions. These computer program instructions may be loaded onto a processing element, such as a computer, server, or other programmable apparatus, to produce a machine, such that the instructions which execute on the processing element create means for implementing the functions specified in the block(s) or step(s) of the control flow diagrams. These computer program instructions may also be stored in a computer-readable memory that can direct the processing element to function in a particular manner, such that the instructions stored in the computer-readable memory produce an article of manufacture including instruction means which implement the function specified in the block(s) or step(s) of the control flow diagrams. The computer program instructions may also be loaded onto the processing element to cause a series of operational steps to be performed on the processing element to produce a computer implemented process such that the instructions which execute on the processing element provide steps for implementing the functions specified in the block(s) or step(s) of the control flow diagrams.

Accordingly, blocks or steps of the control flow diagrams support combinations of means for performing the specified functions, combinations of steps for performing the specified functions, and program instruction means for performing the specified functions. It will also be understood that each block or step of the control flow diagrams, and combinations of blocks or steps in the control flow diagrams, can be implemented by special purpose hardware-based computer systems which perform the specified functions or steps, or combinations of special purpose hardware and computer instructions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for adjusting prices comprising the steps of:
receiving at least one itinerary having an associated price;
modifying the availability of at least one component of the itinerary across a plurality of distribution channels to generate a more competitive price for the itinerary; and
outputting the competitive price and the itinerary.

2. The method according to claim 1, wherein modifying comprises modifying the availability of a class to generate the more competitive price.

3. The method according to claim 2, wherein modifying comprises closing a lower priced class to generate the more competitive price.

4. The method according to claim 1, wherein modifying comprises modifying the availability of the at least one component of the itinerary based on an expected revenue for each of a plurality of differently priced itineraries.

5. The method according to claim 1, wherein modifying comprises modifying the availability of the at least one component of the itinerary based on prices for each of a plurality of competitor's itineraries.

6. The method according to claim 1, wherein modifying occurs in real-time and simultaneously across the plurality of distribution channels.

7. The method according to claim 1, wherein the plurality of distribution channels comprise a plurality of global distribution systems.

8. The method according to claim 1, further comprising determining a probability of selecting the itinerary and calculating an expected revenue for the itinerary.

9. The method according to claim 8, wherein modifying comprises modifying the availability of the at least one component of the itinerary based on the probability and expected revenue, wherein the availability is modified to increase the expected revenue.

10. The method according to claim 8, wherein determining a probability of selection comprises determining a probability using a customer choice model.

11. The method according to claim 10, wherein the customer choice model is a multinomial logit choice model.

12. The method according to claim 10, further comprising calibrating the customer choice model using a conditional logit regression model.

13. The method according to claim 1, further comprising identifying an opportunity to modify the availability of the at least one component of the itinerary.

14. The method according to claim 1, further comprising determining a plurality of options to generate the more competitive price for the itinerary.

15. The method according to claim 14, further comprising refining at least one of the options.

16. The method according to claim 14, wherein determining comprises determining a set of more competitive prices and a set of respective itineraries.

17. The method according to claim 16, wherein the set of respective itineraries is dependent on at least one of leg based, origin and destination based, and origin and destination with time of day based itinerary controls.

18. The method according to claim 14, wherein determining comprises computing a demand for purchasing the plurality of options.

19. The method according to claim 18, wherein computing the demand comprises computing a probability of purchasing the plurality of options.

20. The method according to claim 15, wherein refining comprises computing a revenue resulting from modifying the availability of at least one of the plurality of options.

21. The method according to claim 20, wherein computing the revenue comprises computing the revenue with a bid price model and a modified bid price model.

22. The method according to claim 21, wherein refining comprises determining the difference between the revenue computed by the bid price model and the modified bid price model.

23. The method according to claim 21, wherein computing the revenue with the modified bid price model comprises adjusting demand for the at least one of the plurality of options to reflect the effect of modifying the availability.

24. The method according to claim 21, wherein computing the revenue with the modified bid price model comprises adding a constraint in dual space to require modifying the availability.

25. The method according to claim 15, further comprising terminating the refining step when a more competitive option is determined.

26. The method according to claim 15, wherein refining comprises refining each of the plurality of options.

27. The method according to claim 15, wherein refining comprises refining at least one previously refined option such that the option is re-validated.

28. The method according to claim 1, further comprising updating a yield management system to account for modifying the availability.

29. A computer readable medium containing instructions for causing a computing device to perform the steps of:
receiving at least one itinerary having an associated price;
modifying the availability of at least one component of the itinerary across a plurality of distribution channels to generate a more competitive price for the itinerary; and
outputting the competitive price and the itinerary.

30. The computer readable medium according to claim 29, wherein modifying comprises modifying the availability of a class to generate the more competitive price.

31. The computer readable medium according to claim 30, wherein modifying comprises closing a lower priced class to generate the more competitive price.

32. The computer readable medium according to claim 29, wherein modifying comprises modifying the availability of the at least one component of the itinerary based on an expected revenue for each of a plurality of differently priced itineraries.

33. The computer readable medium according to claim 29, wherein modifying comprises modifying the availability of the at least one component of the itinerary based on prices for each of a plurality of competitor's itineraries.

34. The computer readable medium according to claim 29, wherein modifying occurs in real-time and simultaneously across the plurality of distribution channels.

35. The computer readable medium according to claim 29, wherein the plurality of distribution channels comprise a plurality of global distribution systems.

36. The computer readable medium according to claim 29, further comprising determining a probability of selecting the itinerary and calculating an expected revenue for the itinerary.

37. The computer readable medium according to claim 36, wherein modifying comprises modifying the availability of the at least one component of the itinerary based on the probability and expected revenue, wherein the availability is modified to increase the expected revenue.

38. The computer readable medium according to claim 36, wherein determining a probability of selection comprises determining a probability using a customer choice model.

39. The computer readable medium according to claim 38, wherein the customer choice model is a multinomial logit choice model.

40. The computer readable medium according to claim 38, further comprising calibrating the customer choice model using a conditional logit regression model.

41. The computer readable medium according to claim 29, further comprising identifying an opportunity to modify the availability of the at least one component of the itinerary.

42. The computer readable medium according to claim 29, further comprising determining a plurality of options to generate the more competitive price for the itinerary.

43. The computer readable medium according to claim 42, further comprising refining at least one of the options.

44. The computer readable medium according to claim 42, wherein determining comprises determining a set of more competitive prices and a set of respective itineraries.

45. The computer readable medium according to claim 44, wherein the set of respective itineraries is dependent on at least one of leg based, origin and destination based, and origin and destination with time of day based itinerary controls.

46. The computer readable medium according to claim 42, wherein determining comprises computing a demand for purchasing the plurality of options.

47. The computer readable medium according to claim 46, wherein computing the demand comprises computing a probability of purchasing the plurality of options.

48. The computer readable medium according to claim 43, wherein refining comprises computing a revenue resulting from modifying the availability of at least one of the plurality of options.

49. The computer readable medium according to claim 48, wherein computing the revenue comprises computing the revenue with a bid price model and a modified bid price model.

50. The computer readable medium according to claim 49, wherein refining comprises determining the difference between the revenue computed by the bid price model and the modified bid price model.

51. The computer readable medium according to claim 49, wherein computing the revenue with the modified bid price model comprises adjusting demand for the at least one of the plurality of options to reflect the effect of modifying the availability.

52. The computer readable medium according to claim 49, wherein computing the revenue with the modified bid price model comprises adding a constraint in dual space to require modifying the availability.

53. The computer readable medium according to claim 43, further comprising terminating the refining step when a more competitive option is determined.

54. The computer readable medium according to claim 43, wherein refining comprises refining each of the plurality of options.

55. The computer readable medium according to claim 43, wherein refining comprises refining at least one previously refined option such that the option is re-validated.

56. The computer readable medium according to claim 29, further comprising updating a yield management system to account for modifying the availability.

57. A method for adjusting prices comprising the steps of:
receiving at least one roundtrip itinerary;
determining the availability of the complete roundtrip itinerary in a single transaction with a computerized reservation system; and
modifying the availability of at least one component of the roundtrip itinerary across a plurality of distribution channels.

58. The method according to claim 57, wherein determining comprises determining whether a carrier includes an inventory control for the at least one roundtrip itinerary.

59. A computer readable medium containing instructions for causing a computing device to perform the steps of:
receiving at least one roundtrip itinerary;
determining the availability of the roundtrip itinerary in a single transaction with a computerized reservation system; and
modifying the availability of at least one component of the roundtrip itinerary across a plurality of distribution channels.

60. The computer readable medium according to claim 59, wherein determining comprises determining whether a carrier includes an inventory control for the at least one roundtrip itinerary.

61. A system for adjusting prices comprising:
at least one processing element for receiving at least one roundtrip itinerary, determining the availability of the roundtrip itinerary in a single transaction with a computerized reservation system, and modifying the availability of at least one component of the roundtrip itinerary across a plurality of distribution channels.

62. The system according to claim 61, wherein the processing element determines whether a carrier includes an inventory control for the at least one roundtrip itinerary.

63. A system for adjusting prices comprising:
at least one processing element for receiving at least one itinerary having an associated price, modifying the availability of at least one component of the itinerary across a plurality of distribution channels to generate a more competitive price for the itinerary, and outputting the competitive price and the itinerary.

64. The system according to claim 63, wherein the processing element determines a probability of selecting the itinerary, and calculates an expected revenue for the itinerary.

65. The system according to claim 64, wherein the processing element modifies the availability of the itinerary across a plurality of distribution channels based on the probability and expected revenue.

66. The system according to claim 63, wherein the processing element identifies an opportunity to modify the availability of the itinerary across a plurality of distribution channels to generate a more competitive price for the itinerary.

67. The system according to claim 66, wherein the processing element determines a plurality of options to generate a more competitive price for the itinerary.

68. The system according to claim 67, wherein the processing element refines at least one of the plurality of options.

69. The system according to claim 63, wherein the processing element updates a yield management system to account for modifying the availability.

70. The system according to claim 63, further comprising a client device for inputting a request for travel.
